(19) United States
(12) Patent Application Publication
(10) Pub. No.: US 2010/0302953 A1
(43) Pub. Date: Dec. 2, 2010

(54) Method of coverage evaluation and optimization using triangulation model

(76) Inventor: Xiaoyun Li, Shenzhen (CN)

Correspondence Address: Xiaoyun Li;UCD CASL 3C, 8 Belfield Office Park, Beaver Row, Clonskeagh, Dublin, DUBLIN 4, IE

(21) Appl. No.: 12/453,899

(22) Filed: May 27, 2009

(51) Int. Cl. H04L 12/24

(52) U.S. Cl. 370/252

(57) ABSTRACT

An un-triangulated hole counting method is described in the invention to evaluate the performance of sensing coverage or wireless communication coverage in a randomly and uniformly deployed sensor network or wireless network without knowing the network topology. This method calculates the expected number of un-triangulated holes, which is the un-triangulated area size in the target area divided by mean un-triangulated hole size, given node density and target area size of the network. The present invention thus provides an aid for controlling the degree of coverage in node deployment for randomly deployed sensor networks. It can also aid to choose a suitable common transmission range for all nodes in a wireless network to provide acceptable wireless radio coverage. A position inside a target area is said to be un-triangulated if it is not enclosed by any triangle formed by connectivity links between three mutually connected nodes. An un-triangulated hole is an area enclosed by a polygon formed by links between nodes where each position of the area is un-triangulated.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The present invention relates to coverage evaluation and un-triangulated coverage hole counting in wireless sensor networks, and radio transmission range optimization in wireless networks.

2. Description of the Related Art

The probability of triangulation is closely related to the probability of existence of un-triangulated coverage (or routing) holes and the probability of coverage. Therefore the probabilistic analysis of triangulation is a fundamental topology control tool to maintain expected quality of monitoring and network connectivity. If the node density and target area size of a random deployed sensor network are given, the probabilistic analysis is helpful to select the appropriate transmission range for network connectivity and save power at the same time. Hence this is a statistical tool for topology control to achieve efficient power management and longest network lifetime providing acceptable sensing monitoring integrity and accuracy, as well as connectivity.

A few existing works provided mathematical methods for the calculation of coverage probability. Assume nodes are randomly deployed in the target sensing area according to a two-dimensional Poisson process, with node density λ. Node density λ is the mean number of nodes lying inside a unit disk sensing area, assuming uniform sensing area πR²=1, and hence the sensing range R=1/√π.

P. Hall introduced a method to calculate the probability of coverage (P_{c}) for any single point not located near the boundary of the area S, which is defined by the probability that at least 1 (k≧1) node lies inside the circle with unit area centred there. P_{c} is defined in terms of the Poisson distribution with node density λ:

$${P}_{c} = {\sum }_{k = 1}^{∞} \frac{{λ}^{k} {e}^{- λ}}{k !} = 1 - {e}^{- λ}$$

### BRIEF SUMMARY OF THE INVENTION

The main objective of the invention is to calculate the expected number of un-triangulated holes in a randomly and uniformly deployed sensor network, given node density and target area size, without knowing the network topology. This method can guide the sensor node deployment in large scalar sensor networks when nodes are deployed randomly from such as a helicopter or a ship to a wide area, in order to achieve acceptable sensing coverage using minimum number of sensor nodes.

The second objective is to optimize the radio transmission range in a randomly deployed wireless networks to achieve acceptable networking connectivity and better power saving. The invention calculates the expected number of routing holes in a wireless network given number of wireless nodes, uniform transmission range and target area size. The method can be used to determine optimal transmission range for all wireless nodes in the network to achieve acceptable networking connectivity with limited number of routing holes.

Firstly, the invention calculates the expected un-triangulated area size, given node density and target area size. Node density is the mean number of node inside a unit sensing area covered by a sensor node's sensing range, or the wireless communication area covered by a node's half transmission range.

Then the invention calculates the mean un-triangulated hole size, which is the mean un-triangulated area inside a hole.

Finally, the expected number of un-triangulated hole is calculated, which is the expected un-triangulated area size inside the target area, divided by the mean un-triangulated hole size.

### BRIEF DESCRIPTION OF THE DRAWINGS

The present invention will become more understandable from the detailed description given herein below and the accompanying drawings which are given by way of illustration only, and thus are not limitative of the present invention. In the following figures, assume each node has sensing area defined by a circle with radius R, and a ‘link’ is said to exist between any two nodes which are no less than 2R units to each other.

FIG. 1. shows a position A is triangulated by three nodes {N₀ N₁ N₂}, where nodes {N₀ N₁ N₂} are located inside the disk with radius 2R centred by A. Nodes {N₀ N₁ N₂} are mutually connected within distance less than 2R to each other to form a triangle enclosing A.

FIG. 2. shows the areas S_{N1} (in which node N₁ must lie) when the distance between the closest node N₀ and A is less than R.

FIG. 3. shows the areas S_{N2} (in which node N₂ must lie) when the distance between the closest node N₀ and A is less than R, and node N₁ is within coordinate (x₁, y₁).

FIG. 4. shows the calculation result and simulation result of probability of triangulation.

FIG. 5. shows all possible quadrangles N₁N₃N₂N₄ forming a un-triangulated hole with hole radius (Rₜ).

FIG. 6. shows how a un-triangulated hole with hole radius (Rₜ) is triangulated when the sensing radius is enlarged to R_{t.}

FIG. 7. shows the calculation result of un-triangulated hole size with various hole radius (Rₜ) assuming the un-triangulated hole is a quadrangle area or a ellipse respectively.

FIG. 8. shows how the expected number of holes with various hole radius Rₜ is calculated based on the probability of un-triangulation in the target area.

FIG. 9. shows the expected number of holes in the unit area with various hole densities (Rₜ), and various node densities (λ).

FIG. 10. shows the total number of un-triangulated holes in the unit area (hole density) with various node densities.

FIG. 11. shows boundary effect while detecting a hole.

FIG. 12. shows the calculation result and simulation result of probability of no un-triangulated hole for various target area sizes and various node densities.

FIG. 13. shows the calculation result of probability of no un-triangulated hole considering boundary effect.

### DETAILED DESCRIPTION OF THE INVENTION

### A. Probability of Triangulation

If a point A lies within the area being studied, the probability of triangulation can be estimated, namely the lower bound of the probability that A has three neighbours (each lying within 2R of A) connected to each other by links which form a triangle around A, assuming uniform sensing area πR²=1, and hence the sensing range R=1/√π.

These neighbours are called N₀, N₁, and N₂. It is assumed that the closest neighbour is a vertex of this triangle and that it is called N₀, because the closest node is most likely to triangulate the point. 10⁶ simulations with varied numbers of neighbours showed that if the closest node cannot triangulate A, its probability of being triangulated by any other three nodes is less than 2%, which can be neglected in order to simplify the calculation. To put this more rigorously, it can be stated that the probability of triangulation is greater than or equal to the probability when the closest node to A is involved in triangulating it.

Prob(Triangulation)≧Prob(Triangulation always using the closest node to A)

Thus a lower bound on the probability of triangulation will now be derived. The distance between N₀ and A is x₀, with 0<x₀<2R, assuming each node has circular sensing area of radius R. N₁ and N₂ are further than x₀ from A. It is necessary that 0<x₀<2R/√3, in order for a suitable triangle to exist.

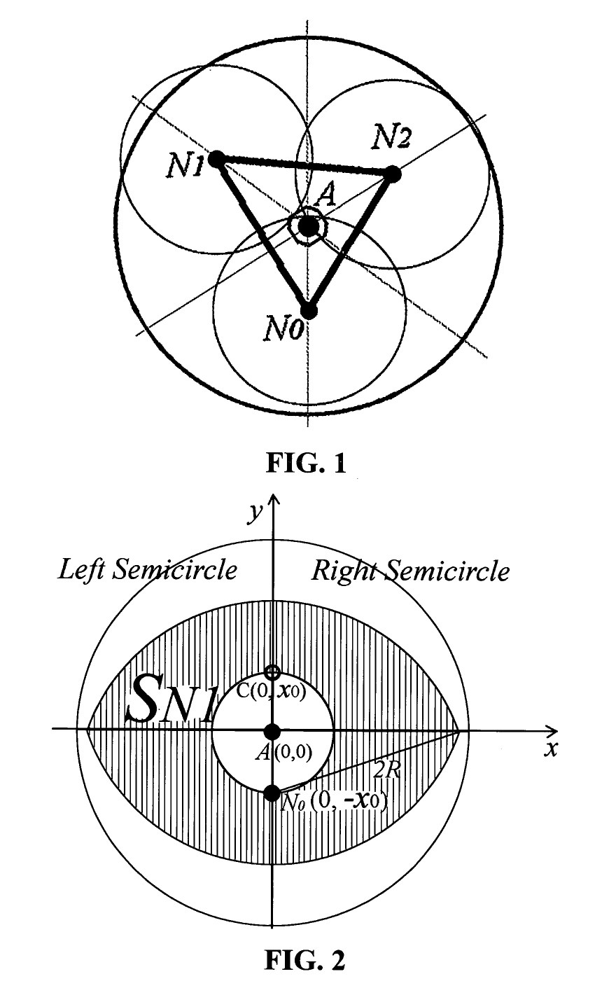

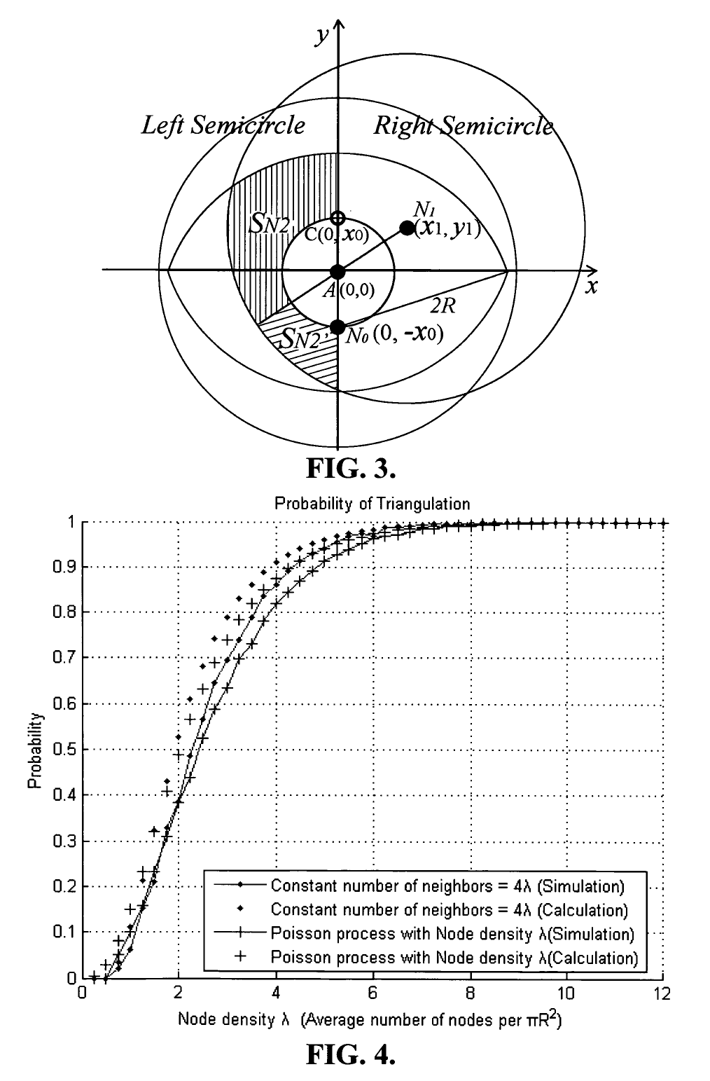

FIGS. 2 and 3 show the areas S_{N1} (in which node N₁ must lie) and S_{N2} (in which node N₂ must lie). Any position in S_{N1} must be less than 2R from N₀ to ensure that N₁ and N₀ are connected, moreover, regardless of what position N₁ occupies within S_{N1}, the area of S_{N2} defined by the condition which follows must be greater than zero. The left (right) semicircle is defined as the area to the left (right) of the y-axis. If N₁ is located in one semicircle (left or right), S_{N2} must be a sub-area of S_{N1} in the other semicircle with each point within it closer than 2R from N₁, so that N₂ is connected to both N₀ and N₁. Point A is therefore triangulated by N₀, N₁ and N₂ as shown in FIG. 1.

Now that S_{N1} and S_{N2} have both been determined, the probability may be found that at least one node falls inside S_{N1} and the other inside S_{N2}, namely the probability of triangulation for some specified value of x₀. The integral of this over the range 0<x₀<2/√3 R is the probability of triangulation by the closest node and two other neighbours.

If both N₁ and N₂ lie in the same semicircle in FIG. 2, N₀, N₁ and N₂ cannot form a triangle enclosing A. Similarly, N₀ and N₂ (or N₁) must not lie to the same side of line AN₁ (or AN₂) (FIG. 3), otherwise A would lie outside the triangle formed by N₀, N₁ and N_{2.} The node in the right semicircle is designated N₁, while N₂ is in the left semicircle.

N₁ must be within 2R of N₀ in order to connect to it, and should be further than x₀ units from A because the distance between the closest node N₀ and A is x₀. Therefore N₁ may lie within S_{N1}, which is defined as the intersection of two circles centred on N₀ and A, each having a radius of 2R. However, the circle centred on A with radius x₀ is excluded. Hence N₁ lies within 2R of both A and N₀.

If N₁ is located to the right (left) side of S_{N1}, then N₂ should lie to the left (right) side of S_{N1} in order to enclose A. Similarly, if N₁ is located to the same side of the y-axis as N₀ (under point A in FIGS. 2 and 3), then N₂ should be on the other side. Therefore the possible area S_{N2} (containing N₂) is the intersection of S_{N1} and the circle centred on N₁ with radius 2R. S_{N2} is on the opposite side of the y-axis from N₁.

Unfortunately, for some positions in S_{N1}, S_{N2} is the empty set because both N₁ and N₂ are located at the left (right) side, or there is no intersecting area above A when N₁ is located beneath it. In order to ensure that S_{N2} is non-empty, it should include at least one point (C_{left} and C_{right}) for the left and right semicircles respectively within S_{N1} that are closest to both N₀ and the y-axis. C_{right} (C_{left}) is the point to the right (left) side of S_{N1} with minimum mean distance to any position in the left (right) side of S_{N1}, therefore it is the closest point to the y-axis. If there is more than one point closest to the y-axis, then C_{right} (C_{left}) is the closest point to both A and N₀ (point C in FIG. 2) but C should lie on the opposite side of the x-axis from N₀ in order to triangulate A. In FIG. 2 where x₀≦R, the two points C_{left} and C_{right} represent the same point named C, where the coordinates of C is (0, x₀).

As discussed above, N₁ and N₂ must lie in different semicircles (left and right), in order to ensure that with N₀, they form a triangle enclosing A (FIG. 3).

For x₀≦R and some specified position of N₁, namely (x₁, y₁), it is possible that N₀ and N₂ lie on the same side of line AN₁, so that N₂ falls within the area S_{N2}′ (FIG. 3). In this case, A is not located inside the triangle formed by N₀, N₁ and N₂. If we consider N₁′, located at (x₁, −y₁), a similar situation occurs when N₂ falls inside S_{N2}. Therefore the mean area of S_{N2} for N₁(x₁, y₁) and N₁′(x₁, −y₁) is (S_{N2}+S_{N2}′)/², as shown in FIG. 3; this result is used in later calculations.

S_{N1}(x₀) and S_{N2}(x₀) are the sizes of the areas in which N₁ and N₂ respectively may each lie for any x₀ (distance between N₀ and A). For the purposes of the calculation, N₁ and N₂ are assumed to lie on the left and right semicircles respectively in order to triangulate position A. Therefore S_{N1}(x₀) and S_{N2}(x₀) are the areas of each region coinciding with only one semicircle. S_{N1}(x₀)=0 for x₀≧2/√3 R.

For 0<x₀≦R (FIG. 3):

$$\begin{matrix}{S}_{{N}_{1}} ( {x}_{0} ) = 2 {\int }_{0}^{2 R - {x}_{0}} ( {\int }_{\sqrt{max ( {x}_{0}^{2} - {y}_{1}^{2} , 0 )}}^{\sqrt{4 {R}^{2} - {( {x}_{0} + {y}_{1} )}^{2}}} d {x}_{1} ) d {y}_{1} \\ = 2 {\int }_{0}^{2 R - {x}_{0}} ( \sqrt{4 {R}^{2} - {( {x}_{0} + {y}_{1} )}^{2}} - \sqrt{max ( {x}_{0}^{2} - {y}_{1}^{2} , 0 )} ) d {y}_{1}\end{matrix}$$

N₁(x₁, y₁) is assumed to lie above the x-axis and to the right of the y-axis only because S_{N1} is symmetrical about both the x-axis and the y-axis.

S_{N2}(x₀) is the integral over x₁ and y₁ of the area S_{N2}(x₁, y₁) which results when N₁ lies at (x_{1,} y₁). For 0<x₀≦R:

$${S}_{{N}_{2}} ( {x}_{0} ) = \frac{1}{{S}_{{N}_{1}} ( {x}_{0} )} {\int }_{0}^{2 R - {x}_{0}} ( 2 {\int }_{\sqrt{max ( {x}_{0}^{2} - {y}_{1}^{2} , 0 )}}^{\sqrt{4 {R}^{2} - {( {x}_{0} + {y}_{1} )}^{2}}} {S}_{{N}_{2}} ( {x}_{1} , {y}_{1} ) d {x}_{1} ) d {y}_{1}$$

$${S}_{{N}_{2}} ( {x}_{1} , {y}_{1} ) = \frac{1}{2} {\int }_{0}^{2 R - {x}_{1}} max [ \begin{matrix}min ( \begin{matrix}\sqrt{4 {R}^{2} - {( {x}_{1} + {x}_{2} )}^{2}} + {y}_{1} , \\ \sqrt{4 {R}^{2} - {x}_{2}^{2}} - {x}_{0}\end{matrix} ) - \\ \sqrt{max ( 0 , {x}_{0}^{2} - {x}_{2}^{2} )} , 0\end{matrix} ] d {x}_{2} + \frac{1}{2} {\int }_{0}^{2 R - {x}_{1}} max [ \begin{matrix}min ( \begin{matrix}\sqrt{4 {R}^{2} - {( {x}_{1} + {x}_{2} )}^{2}} - {y}_{1} , \\ \sqrt{4 {R}^{2} - {x}_{2}^{2}} - {x}_{0}\end{matrix} ) - \\ \sqrt{max ( 0 , {x}_{0}^{2} - {x}_{2}^{2} )} , 0\end{matrix} ] d {x}_{2}$$

For R<x₀≦2R/√3, because the probability that three nodes can triangulate A is very low (<<1%) according to the calculation result, therefore it is not calculated in the invention.

With a 2D Poisson process, the approximation can be made as follows:

For each x₀ (the distance from the closest node to A), the probability of triangulation f(x₀) is Prob(no node in area πx₀²)·Prob(at least one node in area 2πx₀dx₀)·Prob(at least one node in area S_{N1}(x₀) and at least one node in area S_{N2}(x₀), with S_{N1} in either the left or right semicircle), which can be calculated as below:

$$f ( {x}_{0} ) = {e}^{- λ π {x}_{0}^{2}} ( 1 - {e}^{- λ \cdot 2 π {x}_{0} {dx}_{0}} ) [ γ + ( 1 - γ ) γ ]$$

$$Because {e}^{{zdx}_{0}} = 1 + {zdx}_{0} + \frac{{( {zdx}_{0} )}^{2}}{2 !} + \frac{{( {zdx}_{0} )}^{3}}{3 !} + \frac{{( {zdx}_{0} )}^{4}}{4 !} + …$$

where z=−λ·2πx₀, for dx₀→0, therefore e^{zx}^{₀}≈1−λ·2πx₀dx₀.

### Therefore

f(x₀)≈e^{-λπx}^{₀}²[1−(1−λ·2πx₀dx₀)][γ+(1−γ)γ]=e^{-λπx}^{₀}²(2γ−γ²)λ·2πx₀dx₀

γ=(1−e^{-λ·S}^{_{N1}}^{(x}^{₀}⁾)(1−e^{-λ·S}^{_{N2}}^{(x}^{₀}⁾)

γ is the Probability that there is at least one node in area S_{N1}(x₀) and at least one node in area S_{N2}(x₀) for S_{N1} within the right side and S_{N2} within the left side.

The probability of triangulation Pₜ for a specified point (assuming a mean node density of λ in a two-dimensional Poisson process) may be calculated as follows:

$${P}_{t} ( λ ) = {\int }_{0}^{2 R} f ( {x}_{0} ) \approx {\int }_{0}^{R} {e}^{- λ π {x}_{0}^{2}} ( 2 γ - {γ}^{2} ) 2 λ π {x}_{0} d {x}_{0}$$

The probability of triangulation not occurring at a specified point is Pₙₜ(λ):

Pₙₜ(λ)=1−Pₜ(λ) [1]

Ten thousand simulations with varied node densities (λ) were run to confirm the analysis. For each simulation, 4λ nodes are randomly deployed inside a circle with radius 2R centred on point. If A is located within a triangle formed by the closest node N₀ and any other two nodes, all closer than 2R from each other, then A is triangulated. FIG. 4 shows that the simulation results agree with calculations very well for the probability of triangulation at a specified point with exactly 4λ neighbours, with a maximum difference of less than 1% for λ≧5. Furthermore, in contrast to the point in question having a fixed number of neighbours, one thousand simulations with random nodal deployment (two-dimensional Poisson process) for each mean node density λ (12≧λ≧1) were also carried out. Hence the number of neighbours is not necessarily exactly 4λ due to the use of a Poisson process. With λ>4, the analytical results agree with simulation to within 5% (FIG. 4).

### B. Calculation of the Mean Size of a Hole

Assume that all nodes have circular sensing areas of radius R. The hole radius (or triangulated radius) is denoted by Rₜ and is defined as follows. For an un-triangulated hole, Rₜ may be found, where Rₜ>R, so that the hole only becomes triangulated if the sensing radius of all its boundary nodes is increased to at least Rₜ. FIG. 6 shows how a hole lying within quadrangle N₁N₄N₂N₃ can be triangulated by increasing the sensing radius to Rₜ so that each edge cannot be longer than 2Rₜ. In other cases, a hole may be enclosed by more than one connected quadrangle, which can be considered as two or more adjacent holes, however this is neglected in the following analysis because it is rare in high-density networks.

The conditions for a hole to be enclosed by a quadrangle with boundary node sensing radii of exactly Rₜ are defined by the following two points:
1. One diagonal of the quadrangle must be of length 2Rₜ, and the other diagonal must be no shorter than 2Rₜ, so that it can be triangulated by links of length 2Rₜ or greater. And the hole could not be triangulated by links shorter than 2Rₜ, with R<Rₜ.
2. Each edge of the quadrangle must be no longer than 2Rₜ, otherwise the hole cannot not be triangulated by links of this length or shorter.

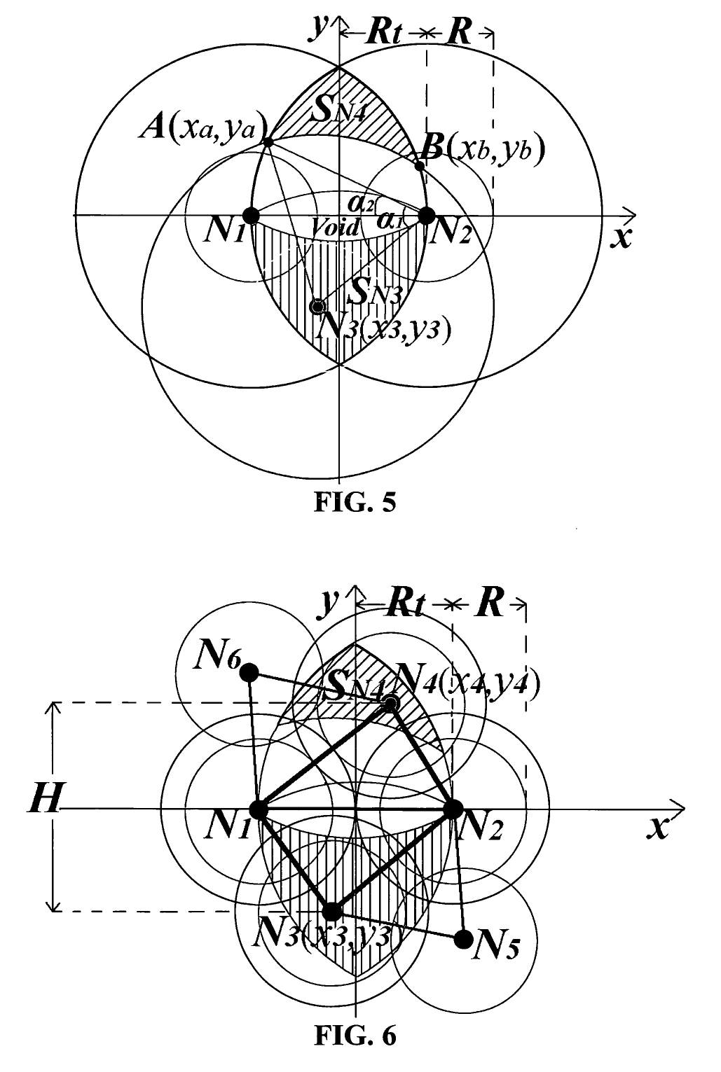

A general description of all possible quadrangles N₁N₃N₂N₄ defined by the above conditions is provided in FIG. 5. N₁ and N₂ are two sensor nodes 2Rₜ units apart, and the large circles centred on these nodes both have radius 2Rₜ. N₃ may lie anywhere inside S_{N3}, which is the intersection of the circles centred on N₁ and N₂, excluding the void area. C and D are the highest and lowest points respectively inside S_{N3}. The void area is the intersection of two circles with radii 2Rₜ centred on C and D (FIG. 5).

N₄ may lie anywhere inside S_{N4}, which is a subset of S_{N3} defined by a specific position of N₃(x₃, y₃), such that the distance between N₃ and any point in S_{N4} is greater than or equal to 2Rₜ, as dictated by condition 1 above—see FIG. 5. If N₃ is in the void area, the distance from it to N₄ cannot be more than 2Rₜ. N₃ and N₄ must be on opposite sides of the x-axis, so that they can be more than 2Rₜ units apart. A and B are the leftmost and rightmost points respectively within S_{N4}.

The area of the quadrangle is Q=HRₜ, where H=y₄−y₃ (FIG. 6). Hₘₑₐₙ is the mean of H, and the mean area of the quadrangle is Qₘₑₐₙ. It is shown below that:

Qₘₑₐₙ=Rₜ×Hₘₑₐₙ≈2.21Rₜ²

For each possible point N₄(x₄, y₄) inside S_{N4}, corresponding to every point N₃(x₃, y₃) inside S_{N3}, the height H of the quadrangle is calculated, in order to derive Hₘₑₐₙ. In the following calculations, x₃<0 and y₃<0, which does not affect the result, because S_{N3} is symmetrical about both x-axis and y-axis.

$${H}_{mean} = \frac{{\int }_{0}^{- Rt} ( {\int }_{- \sqrt{4 {Rt}^{2} - {( Rt - {x}_{3} )}^{2}}}^{\sqrt{3} Rt - \sqrt{4 {Rt}^{2} - {x}_{3}^{2}}} H \times {S}_{N 4} d {y}_{3} ) d {x}_{3}}{{\int }_{0}^{- Rt} ( {\int }_{- \sqrt{4 {Rt}^{2} - {( Rt - {x}_{3} )}^{2}}}^{\sqrt{3} Rt - \sqrt{4 {Rt}^{2} - {x}_{3}^{2}}} {S}_{N 4} d {y}_{3} ) d {x}_{3}} \approx 2.21 Rt$$

$$\begin{matrix}{S}_{N 4} = {\int }_{{x}_{a}}^{{x}_{b}} ( {\int }_{\sqrt{4 {Rt}^{2} - {( {x}_{4} - {x}_{3} )}^{2}} + {y}_{3}}^{\sqrt{4 {Rt}^{2} - {Max ( Rt \pm {x}_{4} )}^{2}}} d {y}_{4} ) d {x}_{4} \\ = {\int }_{{x}_{a}}^{{x}_{b}} [ \begin{matrix}\sqrt{4 {Rt}^{2} - {Max ( Rt \pm {x}_{4} )}^{2}} - \\ ( \sqrt{4 {Rt}^{2} - {( {x}_{4} - {x}_{3} )}^{2}} + {y}_{3} )\end{matrix} ] d {x}_{4}\end{matrix}$$

$$\begin{matrix}H = \frac{{\int }_{{x}_{a}}^{{x}_{b}} ( {\int }_{\sqrt{4 {Rt}^{2} - {( {x}_{4} - {x}_{3} )}^{2}} + {y}_{3}}^{\sqrt{4 {Rt}^{2} - {Max ( Rt \pm {x}_{4} )}^{2}}} {y}_{4} d {y}_{4} ) d {x}_{4}}{{S}_{N 4}} - {y}_{3} \\ = \frac{{\int }_{{x}_{a}}^{{x}_{b}} \frac{\begin{matrix}4 {Rt}^{2} - {Max ( Rt \pm {x}_{4} )}^{2} - \\ {[ \sqrt{4 {Rt}^{2} - {( {x}_{4} - {x}_{3} )}^{2}} + {y}_{3} ]}^{2}\end{matrix}}{2} d {x}_{4}}{{S}_{N 4}} - {y}_{3}\end{matrix}$$

$${α}_{1} = {cos}^{- 1} ( \frac{\sqrt{{( Rt - {x}_{3} )}^{2} + {y}_{3}^{2}} / 2}{2 Rt} ) ; {α}_{2} = {tan}^{- 1} ( \frac{- {y}_{3}}{Rt - {x}_{3}} )$$

$$\begin{matrix}{x}_{a} = Rt - 2 Rt cos ( {α}_{1} - {α}_{2} ) \\ = Rt - 2 Rt cos [ {cos}^{- 1} ( \frac{\sqrt{{( Rt - {x}_{3} )}^{2} + {y}_{3}^{2}} / 2}{2 Rt} ) - {tan}^{- 1} ( \frac{- {y}_{3}}{Rt - {x}_{3}} ) ]\end{matrix}$$

$${x}_{b} = 2 Rt cos [ {cos}^{- 1} ( \frac{\sqrt{{( Rt + {x}_{3} )}^{2} + {y}_{3}^{2}} / 2}{2 Rt} ) - {tan}^{- 1} ( \frac{- {y}_{3}}{Rt + {x}_{3}} ) ] - Rt$$

The un-triangulated area of a hole is not necessarily enclosed by its quadrangle, because although each edge of the quadrangle is no longer than 2Rₜ units, the length of an edge might be greater than 2R (e.g. edge N₂N₃ of FIG. 6). Therefore an un-triangulated area outside edge N₂N₃ exists, which is enclosed by triangle N₂N₅N₃. Hence the un-triangulated area of a hole is larger than the quadrangle area Q if one or more edges of the quadrangle are longer than 2R. FIG. 6 shows that the un-triangulated area of the hole is enclosed by a polygon N₂ N₅ N₃ N₁ N₆ N₄ with six edges, each no longer than 2R.

If all four edges of the quadrangle are longer than 2R, the un-triangulated area of the hole is enclosed by a polygon with at least eight edges. In such a case, assume that un-triangulated area is enclosed by an ellipse with radius Rₜ and height H/2, then the mean un-triangulated area is HₘₑₐₙRₜπ/2≈3.47Rₜ², which is larger than the mean quadrangle size 2.21Rₜ². The assumption of the un-triangulated area being an ellipse does not affect the accuracy of the calculation, as shown below.

If k edges of the quadrangle are longer than 2R (k≦4), then the mean un-triangulated area is:

k/4×ellipse_area+(1−k/4)×quadrangle_area=(k/4)3.47Rₜ²+(1−k/4)2.21Rₜ²

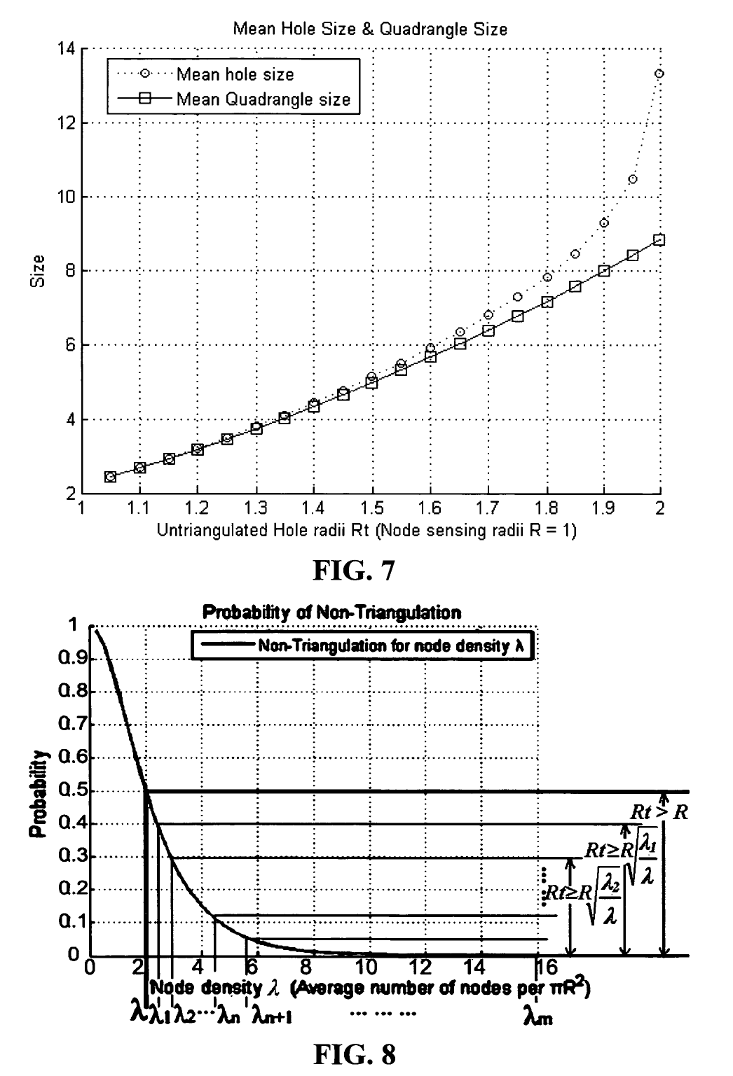

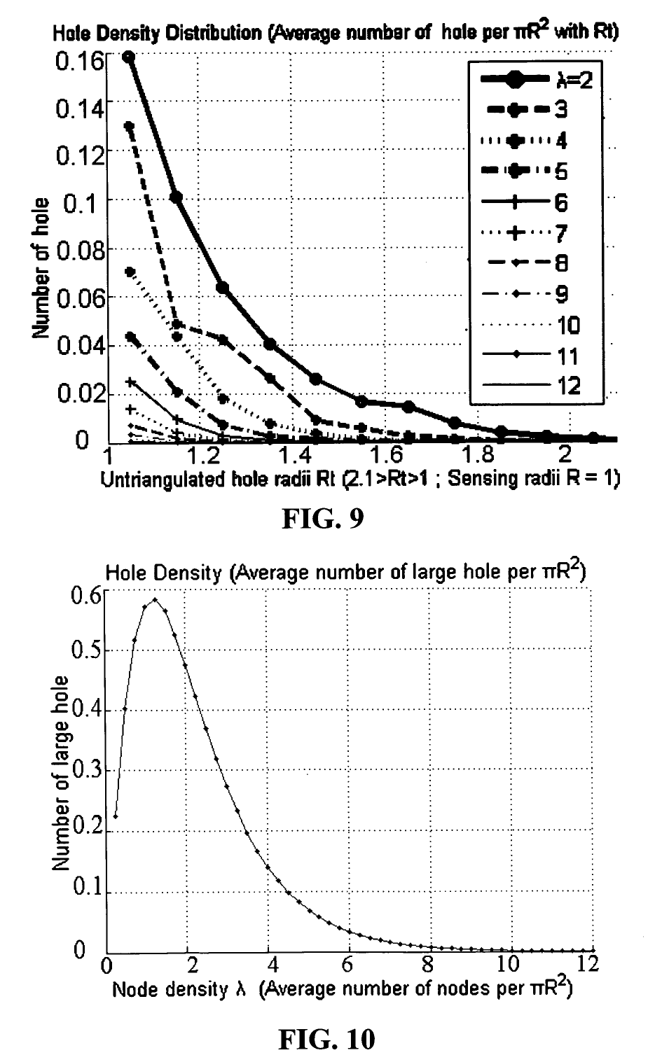

From FIG. 6, the probability that the un-triangulated area is enclosed by such an ellipse could be calculated for different hole radii Rₜ. This is the probability that N₃ (or N₄) is more than 2R units away from N₁ or N₂. FIG. 7 shows that when Rₜ≦1.5R, the un-triangulated area is approximately equal to the quadrangle area, because for Rₜ<1.5R, the un-triangulated area is enclosed by a quadrangle with a probability of over 95%. Since for most holes, later calculations in FIG. 9 show that Rₜ≦1.5R for medium and high node densities (λ≧7), the un-triangulated area of a hole is considered to be equal to the quadrangle size Qₘₑₐₙ in the following calculations.

### C. Calculation of Hole Density Distribution and Hole Counting

The next step is to calculate hₛᵤₘ, the total number of holes inside a unit area, taking into account all hole radii Rₜ (where R<Rₜ<∞):

$${h}_{sum} = {\sum }_{Rt = R}^{∞} \frac{{S}_{n t} ( {R}_{t} ) \times 1}{{Q}_{mean}} = {\sum }_{Rt = R}^{∞} \frac{{S}_{n t} ( {R}_{t} )}{2.21 {R}_{t}^{2}} = {\sum }_{Rt = R}^{∞} \frac{{P}_{n t} ( λ )}{2.21 {R}_{t}^{2}}$$

Sₙₜ(Rₜ) is the expected un-triangulated area within a unit area, for hole radii of Rₜ, which can be derived from the probability of triangulation calculated in [1] of section A. Assuming random deployment following a two-dimensional Poisson process with node density λ, the probability of non triangulation for any point is Pₙₜ(λ). λ is the mean number of nodes lying inside the unit sensing area πR².

Therefore

$${\sum }_{{R}_{t} = R}^{∞} {S}_{n t} ( {R}_{t} ) = {P}_{n t} ( λ ) \times 1 ,$$

which is the expected un-triangulated area in a unit area, including all un-triangulated holes (quadrangles), with hole radii of Rₜ.

Assume λ₀=λ and Rₜ₍₀₎=R. If the sensing radii are enlarged from R to Rₜ₍ᵢ₎ (i>0), then by definition, any un-triangulated holes with hole radii less than Rₜ₍ᵢ₎ would disappear, whereas all other holes would remain un-triangulated. Hence the un-triangulated area Sᵢ with hole radii between Rₜ₍ᵢ₎ and Rₜ₍ᵢ₊₁₎ (i≧0) inside unit area may be calculated as:

Sᵢ=[Pₙₜ(λᵢ)−Pₙₜ(λᵢ₊₁)]·1

λᵢ is the node density for sensing radii of Rₜ₍ᵢ₎, which is the mean number of nodes lying inside an area of πRₜ₍ᵢ₎², as shown in FIG. 8.

$${λ}_{i} = \frac{λ \times π {R}_{t ( i )}^{2}}{π {R}^{2}} = \frac{λ {R}_{t ( i )}^{2}}{{R}^{2}}$$

$${R}_{t ( i )} = \sqrt{\frac{{λ}_{i} \times {R}^{2}}{λ}} = R \sqrt{\frac{{λ}_{i}}{λ}}$$

If the interval Rₜ₍ᵢ₊₁₎−Rₜ₍ᵢ₎→0, then Hᵢ, the expected number of un-triangulated holes inside a unit area for hole radii between Rₜ₍ᵢ₊₁₎ and Rₜ₍ᵢ₎ may be calculated as:

$$\begin{matrix}{H}_{i} = {S}_{i} / {Q}_{mean} ( {R}_{t ( i )} ) \\ = \frac{{P}_{n t} ( {λ}_{i} ) - {P}_{n t} ( {λ}_{i + 1} )}{2.21 {R}_{t ( i )}^{2}} \\ = \frac{{P}_{n t} ( {λ}_{i} ) - {P}_{n t} ( {λ}_{i + 1} )}{2.21 {R}^{2} \frac{{λ}_{i}}{λ}}\end{matrix}$$

Therefore the expected total number of un-triangulated holes hₛᵤₘ inside unit area may be calculated as:

$${h}_{sum} = {\sum }_{i = 0}^{∞} {H}_{i} = {\sum }_{i = 0}^{∞} \frac{{P}_{n t} ( {λ}_{i} ) - {P}_{n t} ( {λ}_{i + 1} )}{2.21 {R}^{2} \frac{{λ}_{i}}{λ}}$$

FIG. 9 shows the expected number of holes in the unit area for the interval Rₜ₍ᵢ₊₁₎−Rₜ₍ᵢ₎=0.1, and 2≦λ≦12. For λ=2, and 1.1R≧Rₜ>R, the expected number of holes in the unit area is 0.16, and not surprisingly, the expected number of holes drops to 0 when Rₜ>2R. However for λ≧5, the expected number of holes is close to zero when Rₜ>1.4R.

FIG. 10 shows the total number of un-triangulated holes in the unit area (hole density). It shows that the hole density is largest (0.58) for λ=1.25, because for lower node density, the nodes are too sparsely deployed to form any un-triangulated polygons (holes), so that the mean hole size is much larger than that of higher node densities. For higher node densities, the hole density drops quickly to less than 0.1 for λ≧4.5. For λ>10, the hole density is close to zero.

Finally, the expected number of holes in the target area S with node density λ is calculated as below:

Eₕₒₗₑ(λ)=hₛᵤₘ×S

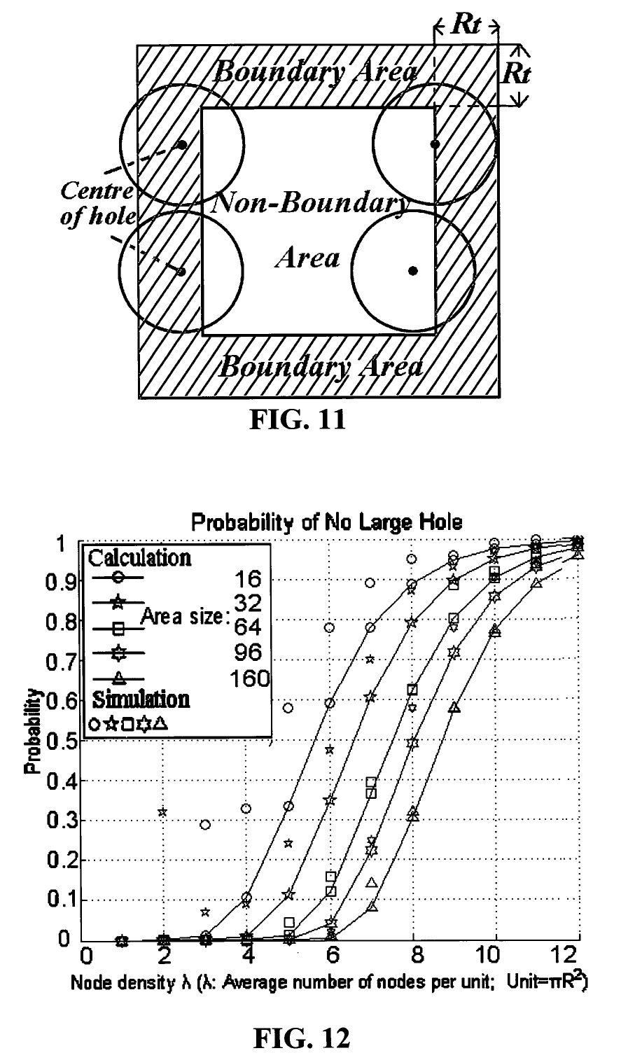

If the centre of a hole with hole radii Rₜ lies less than Rₜ units from the boundary of the target area (FIG. 11), this hole cannot be detected because no nodes are allowed outside the target area. Calculation result shows the mean of Rₜ is approximately 1.1R for 20≧λ≧2. In order to overcome the boundary effect, only holes centred within the non-boundary area, more than Rₜ=1.1R units (R=1/√π) from the boundary, may be calculated (FIG. 11).

Simulations were performed to detected un-triangulated holes inside target areas of between 16 and 160 square units, using Matlab 7.0 as the simulator. For each target area, 100 simulations with random node deployment were performed using the 3MeSH-DR hole detection and recovery algorithm as proposed by Xiaoyun Li and David Hunter, for 12≧λ≧2.

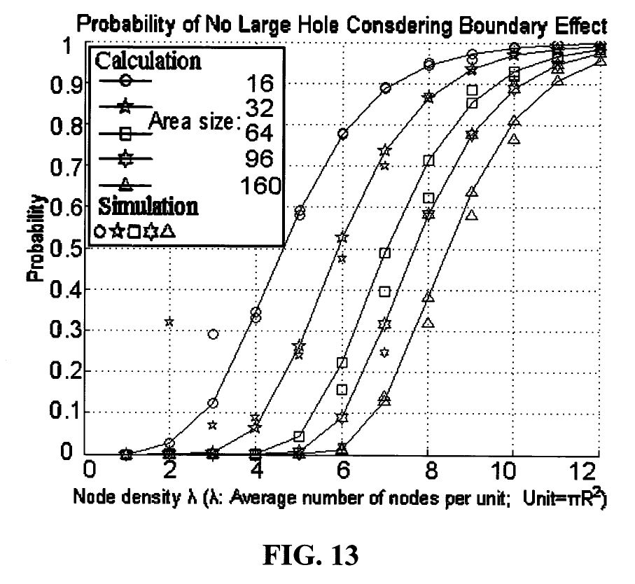

In FIGS. 12 and 13, P_{noHole} (the probability of no un-triangulated hole) is calculated by:

P_{noHole}=e^{-E}^{ₕₒₗₑ}^{(λ)}

The simulation results in FIGS. 12 and 13 show that the probability of no un-triangulated hole increases from less than 10% to more than 98% when the node density increases from 3 to 12 for most target area sizes considered. But for the smallest target area sizes of 16 and 32 square units, the probability of no hole increases for lower node densities (λ≦3), because the mean hole radius for these lower node densities is large (around 1.4R), and some of the holes' radii could be more than 1.8R as shown in FIG. 10. Therefore for small target areas, as one would expect, the boundary effect dominates, indeed, holes with larger hole radii are less likely to be detected. Hence the probability of no hole is higher for low node densities. However for higher node densities (λ≧4), the probability of no hole increases monotonically for target area sizes greater than or equal to 16 square units.

FIG. 12 shows that because of the boundary effect, there is a large offset between the simulation results from the 3MeSH hole detection algorithm and the analytical result. As expected, the offset is smaller for larger areas, due to the decreased influence of the boundary effect. FIG. 13 shows that the offset decreases greatly after considering the boundary effect in the way discussed above. The calculation results agree with the simulations very well for each target area considered with varied node densities, with an average error of less than 5%.

1. A method for estimating the expected number of un-triangulated holes in a randomly and uniformly deployed sensor network or wireless network, said method comprising the steps of:
Calculating the expected un-triangulated area size in the target area given node density and target area size, wherein said node density is the mean number of nodes fallen inside a unit sensing coverage area or unit radio coverage area, wherein said un-triangulated area is an area that each position in the area is not enclosed by any triangle formed by links between three mutually connected nodes;
Calculating the mean un-triangulated hole size given node density of the network, wherein said un-triangulated hole is a area enclosed by a polygon formed by links between nodes where each position in the area is un-triangulated.
Calculating the expected number of un-triangulated hole in the target area, which is the expected un-triangulated area size divided by mean un-triangulated hole size.
